(19) United States
(12) Patent Application Publication
(10) Pub. No.: US 2023/0091180 A1
(43) Pub. Date: Mar. 23, 2023

(54) BOUILLON TABLET

(71) Applicant: SOCIETE DES PRODUITS NESTLE S.A., Vevey (CH)

(72) Inventors: JIMMY PERDANA, Singen (DE); REINHOLD WILLY BETZ, Gottmadingen (DE); KEVIN KURZ, Konstanz (DE); GREGORY TRAPPO, Singen (DE)

(21) Appl. No.: 17/760,467

(22) PCT Filed: Jan. 26, 2021
(86) PCT No.: PCT/EP2021/051730

§ 371 Date: Aug. 10, 2022

(30) Foreign Application Priority Data
Feb. 11, 2020 (EP) 20156511.6

(51) Int. Cl. A23L 23/10; A23P 10/28

(52) U.S. Cl. CPC A23L 23/10; A23P 10/28

(57) ABSTRACT

The invention relates to a bouillon tablet comprising that at least 45 wt % of all ingredients have a median particle diameter Dv50 above 0.6 mm.

### TECHNICAL FIELD

The invention relates to a bouillon tablet. In particularly the invention relates to a bouillon tablet comprising that at least 45 wt % of all ingredients have a median particle diameter Dv50 above 0.6 mm.

### BACKGROUND

A conventional way of manufacturing bouillon tablets comprises mixing powdered bouillon components and pressing the mix into tablet form. The reason to compact powders in a regular form presents several advantages for the commercialization (e.g. reduction of volume, optimization of packaging material usage, shelf life and convenience). A minimum hardness is necessary to allow a wrapping of the bouillon tablet. A maximum hardness ensures that a normal user can break the bouillon tablet within fingers without the use of additional tools or appliances. Two ways of binding do exist for such kind of bouillon tablet: A fat binding system or an amorphous ingredient binding system. A conventional way of manufacturing bouillon tablets comprises mixing powdered bouillon components with fat and pressing the mix into a tablet. In this type of bouillon tablet fat is the main ingredient holding the structure together.

Nowadays there is a nutritional trend to avoid or at least reduce the consumption of fats rich in saturated fatty acids and to preferably consume oils rich in monounsaturated fatty acids and/or polyunsaturated fatty acids. WO2004/049831 describes how it is possible to have very little solid fat entrapped in a hard bouillon tablet provided the tablet also comprises crystals, a filler and a sticking agent. The sticking agent may comprise ingredients the addition of which (combined with an adequate increase of the water activity) impart a glass transition temperature to the final mixture which may be relatively easily exceeded during tableting. Such ingredients include meat extract, processed flavors and/or vegetables extracts.

EP3123875 discloses a bouillon cube comprising 22-85 wt. % inorganic salt; 0.8-8 wt. % of xanthan gum; 0-20 wt. % of sugar selected from monosaccharides, disaccharides and combinations thereof, 0-25 w. % starch component selected from native starch, pregelatinised starch, maltodextrin, modified starch and combinations thereof; and 0-45 wt. % of vegetable matter selected from vegetables, herbs, spices and combinations thereof. The use of xanthan gum in the specified concentration offers the advantage that the savoury concentrate mixture does not forma sticky mass even if said mixture has a relatively high moisture content. Thus, the savoury mixture can easily be processed and converted into shaped articles or granules. Xanthan as ingredient has an E number (E415) and is therefore not considered for many consumers as natural. In addition, as shown in the examples a higher amount of vegetable matter is only applied in case of a bouillon powder and not in a pressed cube.

WO2004017762 discloses bouillon cubes used for preparing a food product comprising 0.1-80 wt % salt and/or MSG, 20-99 wt % sugar, 0.05-50 wt % fresh herbs or spices. A slow disintegration time is described and therefore a product having a delayed and/or long-lasting release of flavoring ingredient during the preparation of food products.

WO2010006907 discloses a savoury food product, comprising salt and/or fat, and further comprising a plant material comprising chlorophyll, and a food grade blue-coloured ingredient. The plant material comprising chlorophyll may still discolor to yellowish (or later brownish) colour, but the presence of a blue-coloured ingredient can surprisingly counter balance such (to at least some extent), in such a way that to the human naked eye the colour of the plant material comprising chlorophyll still appears as (fresh) green, or at least much greener than would be the case without incorporating said blue-coloured ingredient into the savoury food product.

Sticking agents used to bind together bouillon cubes with low fat contents are typically hygroscopic amorphous ingredients. These are activated in the bouillon mixture by the addition of water. This process of water addition can be problematic, for example it is difficult to ensure homogenous distribution of the water and a storage time up to 24 hours is needed to reach a water activity equilibrium. Crust formation may occur which requires stopping the mixer for cleaning. Sometimes lumps are formed in the mixtures which causes quality defects in the finished pressed tablets. In addition post hardening of the bouillon tablet may occur.

One drawback of the pressed bouillon tablet from powder is its look of being un-natural for many consumers. Only a limited amount of herbs and spices can be added in commercial available bouillon tablets and/or are not visible due to the small particle size. These bouillon tablets do not look fresh and therefore unhealthy for many consumers. One further drawback is often the disintegration time and the crumbliness of bouillon tablets. WO2004112513 describes a process to form granules of powders having different colors and pressing the granules to a marbled bouillon tablet. Despite the marbled color effect of the bouillon tablet it looks like a standard pressed bouillon tablet as the granule structure is destroyed by pressing and has the same technical drawback as mentioned above. In case a more natural looking bouillon tablet with visible ingredients for the consumer and especially with a higher amounts of visible herbs and spices are produced the standard bouillon tablet pressing is not suitable.

Hence, there is a persisting need in the art to find improved processes for forming bouillon tablets, especially for bouillon tablets looking more natural with visible ingredients for the consumer and/or disintegrate fast in an aqueous solution.

### SUMMARY OF THE INVENTION

The object of the present invention is to improve the state of the art or at least provide an alternative for a bouillon tablet:
i) the bouillon tablet looks more natural;
ii) used ingredients are visible;
iii) used ingredients especially salt and pieces of plant material are visible and can be recognized by the consumer;
iv) higher amounts of pieces of plant material;
v) avoid using fat especially palm fat;
vi) avoid the usage of hydrogenated or interesterified oils and fats;
vii) a low fat bouillon tablet, preferably a bouillon tablet with no fat;
viii) reach a shelf life over 12 month with the same sensory properties;
ix) a bouillon tablet having good disintegration properties in hot water;
x) reduced in sodium salt;
xi) the process provide a good machinability;
xii) provide good mixing properties;
xiii) provide good forming (cutting) properties;
xiv) minimize weight variation of formed (cutted) bouillon tablet;
xv) avoid storage time during processing;
xvi) no segregation of mixed ingredients during the process.

The object of the present invention is achieved by the subject matter of the independent claims. The dependent claims further develop the idea of the present invention.

Accordingly, the present invention provides in a first aspect a bouillon tablet comprising:
i) 20-60 wt % crystalline salt (weight of the composition);
ii) 15-65 wt % pieces of plant material (weight of the composition);
iii) 5-40 wt % Saccharide (weight of the composition);
   wherein the crystalline salt has a median particle diameter Dv50 in the range of 0.6 to 2.5 mm and wherein at least 45 wt % of all ingredients have a median particle diameter Dv50 above 0.6 mm.

In a second aspect, the invention relates to a process to manufacture a bouillon tablet comprising the steps of:
a) mixing 20-60 wt % crystalline salt, 15-65 wt % pieces of plant material to obtain a dry composition;
b) adding a saccharide solution to the dry composition of step a) and further mixing to result in a bouillon mass;
c) forming a bouillon tablet from the bouillon mass;
d) drying the bouillon tablet;
   wherein the crystalline salt has a median particle diameter Dv50 in the range of 0.6 to 2.5 mm and wherein the saccharide solution has a Brix value between 72 to 87° and wherein at least 45 wt % of all ingredients have a median particle diameter Dv50 above 0.6 mm.

A third aspect of the invention relates to a food product prepared by making use of the bouillon tablet of the invention.

It has been surprisingly found by the inventors that a bouillon tablet comprising that at least 45 wt % of all ingredients have a median particle diameter Dv50 above 0.6 mm:
used coarse salt and pieces of plant material are visible and therefore the bouillon tablet looks more natural;
used ingredients can be recognized by the consumer;
particle size of the ingredients, especially of plant material, are not destroyed by process;
higher amounts of pieces of plant material can be present;
the bouillon tablet has a faster disintegration time in an aqueous solution, especially when compared to standard bouillon tablets;
the usage of palm fat or hydrogenated fat can be avoided;
low fat bouillon tablet, preferably no fat is used;
the bouillon tablet reaches a shelf life over 12 month with the same sensory properties;
enables the user to break the bouillon tablet in crumbles;
the bouillon tablet has a hardness of at least 80N;
the bouillon tablet has a lower density compared to a commercial available bouillon tablet;
no segregation of mixed ingredients during the process;
good slab forming properties;
good cutting performance to obtain a bouillon tablet;
minimize weight variation of formed (cutted) bouillon tablet;
pieces of plant material still look fresh after drying the bouillon tablet.

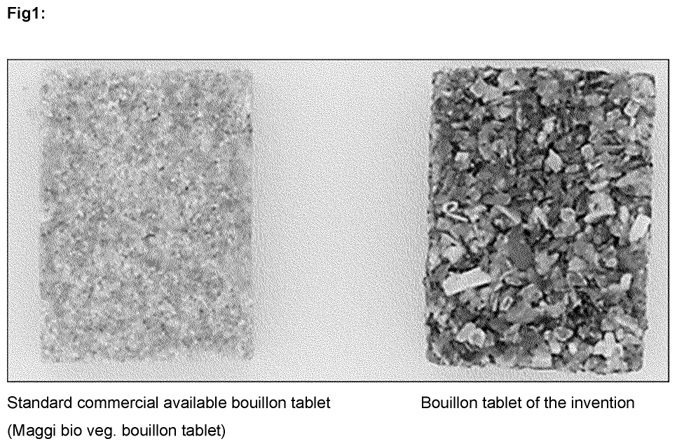

FIG. 1 shows a commercially available bouillon tablet and a bouillon tablet obtainable by the process of the invention with visible ingredients.

### DETAILED DESCRIPTION

The present invention pertains to a bouillon tablet comprising:
i) 20-60 wt % crystalline salt (weight of the composition);
ii) 15-65 wt % pieces of plant material (weight of the composition);
iii) 5-40 wt % Saccharide (weight of the composition);
   wherein the crystalline salt has a median particle diameter Dv50 in the range of 0.6 to 2.5 mm and wherein at least 45 wt % of all ingredients have a median particle diameter Dv50 above 0.6 mm.

In a second aspect, the invention pertains to a process to manufacture a bouillon tablet comprising the steps of:
a) mixing 20-60 wt % crystalline salt, 15-65 wt % pieces of plant material to obtain a dry composition;
b) adding a saccharide solution to the dry composition of step a) and further mixing to result in a bouillon mass;
c) forming a bouillon tablet from the bouillon mass;
d) drying the bouillon tablet;
   wherein the crystalline salt has a median particle diameter Dv50 in the range of 0.6 to 2.5 mm and wherein the saccharide solution has a Brix value between 72 to 87° and wherein at least 45 wt % of all ingredients have a median particle diameter Dv50 above 0.6 mm.

A third aspect of the invention relates to a food product prepared by making use of the bouillon tablet of the invention.

In a preferred embodiment the present invention pertains to a bouillon tablet comprising:
i) 20-60 wt % crystalline salt (weight of the composition);
ii) 15-65 wt % pieces of plant material (weight of the composition);
iii) 5-40 wt % Oligosaccharide (weight of the composition);
   wherein the crystalline salt has a median particle diameter Dv50 in the range of 0.6 to 2.5 mm and wherein at least 45 wt % of all ingredients have a median particle diameter Dv50 above 0.6 mm.

“Bouillon tablet” means a tablet or cube or other geometric forms obtained by forming or moulding a loose ingredient mix into a tablet form, bar form, cube form or other geometric form as sphere, ellipsoid, cuboid, rectangular, cylinder, cone or pyramid form, preferably a tablet form or bar form or cube form. The resulting tablet has a weight between 2 to 40 g. Bar within this invention means a shape and/or form similar to a cereal bar.

“Crystalline salt” according to this invention means sodium chloride, but can also comprise other edible salts capable of imparting or enhancing a salty taste perception, such as potassium chloride or ammonium chloride or any combination thereof. The bouillon tablet comprises 20 to 65% (by weight of the composition) crystalline salt, preferably 20 to 60%, preferably 20 to 55%, preferably 20 to 50%, preferably 20 to 45%, preferably 20 to 40%, preferably 25 to 65%, preferably 25 to 60%, preferably 25 to 55%, preferably 25 to 50%, preferably 25 to 45%, preferably 30 to 65%; preferably 30 to 60%, preferably between 30 to 55%, preferably 30 to 50%, preferably 30 to 45% (by weight of the composition). In a further embodiment, the crystalline salt has a median particle diameter Dv50 in the range of 0.6 to 2.5, preferably a median particle diameter Dv50 in the range of 0.7 to 2.5 mm, preferably a median particle diameter Dv50 in the range of 0.8 to 2.5 mm, preferably a median particle diameter Dv50 in the range of 0.9 to 2.5 mm, preferably a median particle diameter Dv50 in the range of 0.95 to 2.50 mm, preferably a median particle diameter Dv50 in the range of 1.00 to 2.5 mm, preferably a median particle diameter Dv50 in the range of 1.05 to 2.50 mm, preferably a median particle diameter Dv50 in the range of 1.10 to 2.50 mm, preferably a median particle diameter Dv50 in the range of 0.6 to 1.5 mm, preferably a median particle diameter Dv50 in the range of 0.7 to 1.5 mm, preferably a median particle diameter Dv50 in the range of 0.8 to 1.5 mm, preferably a median particle diameter Dv50 in the range of 0.9 to 1.5 mm, preferably a median particle diameter Dv50 in the range of 0.80 to 1.20 mm. Standard salt used for commercial available bouillon tablets has a median particle diameter Dv50 in the range of 0.15 to 0.55 mm, preferably 0.30 to 0.50 mm.

In a further embodiment, the composition comprises up to 10 wt % crystalline MSG (by weight of the composition), preferably up to 8 wt %, preferably between 0 to 10%, preferably between 0.5 to 10%, preferably between 1 to 8%, preferably between 2 to 8% (by weight of the composition). In a further embodiment, the crystalline MSG has a median particle diameter Dv50 in the range of 0.3 to 2.5 mm, preferably a median particle diameter Dv50 in the range of 0.4 to 2.5 mm, preferably a median particle diameter Dv50 in the range of 0.5 to 2.5 mm, preferably a median particle diameter Dv50 in the range of 0.6 to 2.5 mm, preferably a median particle diameter Dv50 in the range of 0.7 to 2.5 mm, preferably a median particle diameter Dv50 in the range of 0.8 to 2.5 mm, preferably a median particle diameter Dv50 in the range of 0.9 to 2.5 mm, preferably a median particle diameter Dv50 in the range of 1.0 to 2.5 mm, preferably a median particle diameter Dv50 in the range of 1.1 to 2.5 mm, preferably a median particle diameter Dv50 in the range of 0.3 to 1.5 mm, preferably a median particle diameter Dv50 in the range of 0.4 to 1.5 mm, preferably a median particle diameter Dv50 in the range of 0.5 to 1.5 mm, preferably a median particle diameter Dv50 in the range of 0.6 to 1.5 mm, preferably a median particle diameter Dv50 in the range of 0.7 to 1.5 mm, preferably a median particle diameter Dv50 in the range of 0.8 to 1.5 mm, preferably a median particle diameter Dv50 in the range of 1.00 to 1.5 mm, preferably a median particle diameter Dv50 in the range of 0.5 to 1.2 mm, preferably a median particle diameter Dv50 in the range of 0.7 to 1.2 mm.

In a further embodiment, pieces of plant material is selected from the group consisting of pieces of parsley, celery, fenugreek, lovage, rosemary, marjoram, dill, tarragon, coriander, leek, ginger, lemongrass, curcuma, chili, ginger, paprika, mustard, garlic, onion, shallots, turmeric, tomato, oregano, thyme, basil, chilies, paprika, mushrooms, pimento, jalapeno pepper, white pepper, black pepper or combinations of these. In a preferred embodiment pieces of plant material are selected from the group of garlic, onion, tomato, pepper, parsley, leek, coriander, shallot or combination thereof. In a further embodiment, the bouillon tablet comprises pieces of plant material in an amount in the range of 15 to 65%, preferably between 20 to 60%, preferably between 25 to 60%, preferably between 25 to 55%, preferably between 25 to 50%, preferably between 30 to 60%, preferably between 30 to 55%, preferably between 30 to 50%, preferably between 35 to 60%, preferably between 35 to 55% (by weight of the composition). In a further embodiment the pieces of plant material have a median particle diameter Dv50 in the range of 0.7 to 9 mm, preferably a median particle diameter Dv50 in the range of 0.7 to 8 mm, preferably a median particle diameter Dv50 in the range of 0.7 to 7 mm, preferably a median particle diameter Dv50 in the range of 0.7 to 6 mm, preferably a median particle diameter Dv50 in the range of 0.7 to 5 mm, preferably a median particle diameter Dv50 in the range of 0.7 to 4 mm, preferably a median particle diameter Dv50 in the range of 0.7 to 3 mm, preferably a median particle diameter Dv50 in the range of 0.7 to 2 mm, preferably a median particle diameter Dv50 in the range of 0.8 to 8 mm, preferably a median particle diameter Dv50 in the range of 0.8 to 5 mm, preferably a median particle diameter Dv50 in the range of 0.8 to 4 mm, preferably a median particle diameter Dv50 in the range of 0.8 to 3 mm, preferably a median particle diameter Dv50 in the range of 0.8 to 2 mm, preferably a median particle diameter Dv50 in the range of 0.9 to 8.0 mm, preferably a median particle diameter Dv50 in the range of 0.9 to 6.0 mm, preferably a median particle diameter Dv50 in the range of 0.9 to 5.0 mm, preferably a median particle diameter Dv50 in the range of 0.9 to 4.0 mm, preferably a median particle diameter Dv50 in the range of 0.9 to 3 mm, preferably a median particle diameter Dv50 in the range of 0.9 to 2 mm, preferably a median particle diameter Dv50 in the range of 1.0 to 8.0 mm, preferably a median particle diameter Dv50 in the range of 1.0 to 6.0 mm, preferably a median particle diameter Dv50 in the range of 1.0 to 5.0 mm, preferably a median particle diameter Dv50 in the range of 1.0 to 4.0 mm, preferably a median particle diameter Dv50 in the range of 1.0 to 3.0 mm, preferably a median particle diameter Dv50 in the range of 1.0 to 2 mm.

In a further embodiment, pieces of animal material is selected from the group consisting of chicken, beef, pork, fish or combination thereof. In a further embodiment, the bouillon tablet comprises pieces of animal material in an amount in the range of 0 to 25% (by weight of the composition), preferably between 1 to 25%, preferably between 5 to 25%, preferably between 5 to 20% (by weight of the composition). In a further embodiment the pieces of animal material have a median particle diameter Dv50 in the range of 0.7 to 9 mm, preferably a median particle diameter Dv50 in the range of 0.7 to 8 mm, preferably a median particle diameter Dv50 in the range of 0.7 to 7 mm, preferably a median particle diameter Dv50 in the range of 0.7 to 6 mm, preferably a median particle diameter Dv50 in the range of 0.7 to 5 mm, preferably a median particle diameter Dv50 in the range of 0.7 to 4 mm, preferably a median particle diameter Dv50 in the range of 0.7 to 3 mm, preferably a median particle diameter Dv50 in the range of 0.8 to 8 mm, preferably a median particle diameter Dv50 in the range of 0.8 to 5 mm, preferably a median particle diameter Dv50 in the range of 0.8 to 4 mm, preferably a median particle diameter Dv50 in the range of 0.8 to 3 mm, preferably a median particle diameter Dv50 in the range of 0.9 to 8.0 mm, preferably a median particle diameter Dv50 in the range of 0.9 to 6.0 mm, preferably a median particle diameter Dv50 in the range of 0.9 to 5.0 mm, preferably a median particle diameter Dv50 in the range of 0.9 to 4.0 mm, preferably a median particle diameter Dv50 in the range of 0.9 to 3 mm, preferably a median particle diameter Dv50 in the range of 1.0 to 8.0 mm, preferably a median particle diameter Dv50 in the range of 1.0 to 6.0 mm, preferably a median particle diameter Dv50 in the range of 1.0 to 5.0 mm, preferably a median particle diameter Dv50 in the range of 1.0 to 4.0 mm, preferably a median particle diameter Dv50 in the range of 1.0 to 3.0 mm.

The median particle diameter Dv50 is used in the conventional sense as the median of the particle size distribution. Median values are defined as the value where half of the population resides above this point, and half resides below this point. The Dv50 is the size that splits the distribution with half above and half below this diameter. The particle size distribution Dv50 has been measured within this invention by selected sieves. In an embodiment the particle size Dv50 has been measured by selected sieves according to Retsch AS200. Alternative it may be measured by laser light scattering, microscopy or microscopy combined with image analysis. For example, the particle size distribution may be measured by laser light scattering. Since the primary result from laser diffraction is a volume distribution, the Dv50 cited is the volume median.

In an embodiment, the bouillon tablet further comprises amorphous ingredients, for example up to 10 wt % amorphous ingredients (by weight of the composition), preferably up to 7 wt % amorphous ingredients, preferably up to 5 wt % amorphous ingredients, preferably the bouillon tablet comprises amorphous ingredients in an amount in the range of 0 to 10% amorphous ingredients, preferably 0.5 to 10%, preferably 0.5 to 9%, preferably 0.5 to 5%, preferably 1 to 10%, preferably 2 to 10%, preferably 2 to 9%, preferably 2 to 5%, preferably 3 to 9%, preferably 3 to 8% (by weight of the composition). The term “amorphous ingredients” according to this invention means ingredients selected from the group consisting of yeast extract, vegetable powder, animal extract, bacterial extract, vegetable extract, animal powder, reaction flavour, hydrolyzed plant protein, or combinations of thereof. In an embodiment, the amorphous ingredients are selected from the group comprising yeast extract, chicken extract, onion powder, garlic powder, celery root powder, tomato powder, bacterial extract, reaction flavour or combinations of thereof. A bacterial extract is described within WO2009040150 or WO2010105842. A vegetable extract is described within WO2013092296. Vegetable powder means at least one ingredient of onion powder, garlic powder, tomato powder, celery root powder or a combination thereof. Animal powder means at least one ingredient of meat powder, fish powder, crustacean powder or combination thereof. Meat powder means chicken powder or beef powder. Animal extract means at least one ingredient of meat extract, fish extract, crustacean extract or combination thereof. In a further embodiment, the bouillon tablet comprises yeast extract in an amount in the range of 0 to 10% (by weight of the composition), preferably between 0.1 to 10%, preferably between 0.1 to 5%, preferably between 1 to 7%, preferably between 2 to 6% (by weight of the composition). In a further embodiment, the bouillon tablet comprises vegetable powder in an amount in the range of 0 to 10% (by weight of the composition), preferably between 0.1 to 10%, preferably between 0.1 to 7%, preferably between 0.1 to 5% (by weight of the composition). In a further embodiment, the bouillon tablet comprises animal extract in an amount in the range of 0 to 10% (by weight of the composition), preferably between 0.1 to 10%, preferably between 0.1 to 5% (by weight of the composition). In a further embodiment, the bouillon tablet comprises bacterial extract in an amount in the range of 0 to 10% (by weight of the composition), preferably between 0.1 to 10%, preferably between 0.1 to 8%, preferably between 0.1 to 5%, preferably between 1 to 10%, preferably between 2 to 8% (by weight of the composition). In a further embodiment, the bouillon tablet comprises vegetable extract in an amount in the range of 0 to 10% (by weight of the composition), preferably between 0.1 to 10%, preferably between 0.1 to 5% (by weight of the composition). In a further embodiment, the bouillon tablet comprises meat powder, fish powder or crustacean powder in an amount in the range of 0 to 10% (by weight of the composition), preferably between 0.1 to 10%, preferably between 0.1 to 5% (by weight of the composition). In a further embodiment, the bouillon tablet comprises reaction flavour in an amount in the range of 0 to 10% (by weight of the composition), preferably between 0.1 to 10%, preferably between 0.1 to 5% (by weight of the composition). Reaction flavours may preferably be amino acids and reducing sugars which react together on the application of heat via the Maillard reaction. In a further embodiment, the bouillon tablet comprises hydrolyzed plant protein in an amount in the range of 0 to 10% (by weight of the composition), preferably between 0.1 to 10%, preferably between 0.1 to 5% (by weight of the composition). In a further embodiment, the bouillon tablet comprises chicken extract, beef extract, fish extract or crustacean extract in an amount in the range of 0 to 5% (by weight of the composition), preferably between 0.5 to 5% (by weight of the composition). In a further embodiment, the bouillon tablet comprises onion powder in an amount in the range of 0 to 10% (by weight of the composition), preferably between 0.1 to 10%, preferably between 0.1 to 5% (by weight of the composition). In a further embodiment, the bouillon tablet comprises celery root powder in an amount in the range of 0 to 10% (by weight of the composition), preferably between 0.1 to 10%, preferably between 0.1 to 5% (by weight of the composition). In a further embodiment, the bouillon tablet comprises tomato powder in an amount in the range of 0 to 10% (by weight of the composition), preferably between 0.1 to 10%, preferably between 0.1 to 5% by weight of the composition).

In an embodiment, the composition of the bouillon tablet further comprises that at least 45 wt % of all ingredients (by weight of the composition) have a median particle diameter Dv50 above 0.6 mm, preferably at least 50 wt % of all ingredients have a median particle diameter Dv50 above 0.6 mm, preferably at least 55 wt % of all ingredients have a median particle diameter Dv50 above 0.6 mm, preferably at least 60 wt % of all ingredients have a median particle diameter Dv50 above 0.6 mm, preferably at least 65 wt % of all ingredients have a median particle diameter Dv50 above 0.6 mm, preferably at least 70 wt % of all ingredients have a median particle diameter Dv50 above 0.6 mm, preferably at least 75 wt % of all ingredients have a median particle diameter Dv50 above 0.6 mm, preferably at least 80 wt % of all ingredients have a median particle diameter Dv50 above 0.6 mm, preferably between 45 to 90 wt % of all ingredients have a median particle diameter Dv50 above 0.6 mm, preferably between 50 to 90 wt % of all ingredients have a median particle diameter Dv50 above 0.6 mm, preferably between 55 to 90 wt % of all ingredients have a median particle diameter Dv50 above 0.6 mm, preferably between 60 to 90 wt % of all ingredients have a median particle diameter Dv50 above 0.6 mm, preferably between 65 to 90 wt % of all ingredients have a median particle diameter Dv50 above 0.6 mm, preferably between 45 to 90 wt % of all ingredients have a median particle diameter Dv50 between 0.6 to 9.0 mm, preferably between 50 to 90 wt % of all ingredients have a median particle diameter Dv50 between 0.6 to 9.0 mm, preferably between 55 to 90 wt % of all ingredients have a median particle diameter Dv50 between 0.6 to 9.0 mm, preferably between 45 to 90 wt % of all ingredients have a median particle diameter Dv50 between 0.6 to 4.0 mm, preferably between 50 to 90 wt % of all ingredients have a median particle diameter Dv50 between 0.6 to 4.0 mm, preferably between 55 to 90 wt % of all ingredients have a median particle diameter Dv50 between 0.6 to 4.0 mm, preferably between 60 to 90 wt % of all ingredients have a median particle diameter Dv50 between 0.6 to 9.0 mm, preferably between 60 to 90 wt % of all ingredients have a median particle diameter Dv50 between 0.6 to 4.0 mm, preferably between 65 to 90 wt % of all ingredients have a median particle diameter Dv50 between 0.6 to 9.0 mm, preferably between 65 to 90 wt % of all ingredients have a median particle diameter Dv50 between 0.6 to 4.0 mm, preferably at least 45 wt % of all ingredients have a median particle diameter Dv50 above 0.7 mm, preferably at least 50 wt % of all ingredients have a median particle diameter Dv50 above 0.7 mm, preferably at least 55 wt % of all ingredients have a median particle diameter Dv50 above 0.7 mm, preferably at least 60 wt % of all ingredients have a median particle diameter Dv50 above 0.7 mm, preferably at least 65 wt % of all ingredients have a median particle diameter Dv50 above 0.7 mm, preferably at least 70 wt % of all ingredients have a median particle diameter Dv50 above 0.7 mm, preferably at least 75 wt % of all ingredients have a median particle diameter Dv50 above 0.7 mm, preferably at least 80 wt % of all ingredients have a median particle diameter Dv50 above 0.7 mm, preferably between 45 to 90 wt % of all ingredients have a median particle diameter Dv50 above 0.7 mm, preferably between 50 to 90 wt % of all ingredients have a median particle diameter Dv50 above 0.7 mm, preferably between 55 to 90 wt % of all ingredients have a median particle diameter Dv50 above 0.7 mm, preferably between 60 to 90 wt % of all ingredients have a median particle diameter Dv50 above 0.7 mm, preferably between 65 to 90 wt % of all ingredients have a median particle diameter Dv50 above 0.7 mm, preferably between 45 to 90 wt % of all ingredients have a median particle diameter Dv50 between 0.7 to 9.0 mm, preferably between 50 to 90 wt % of all ingredients have a median particle diameter Dv50 between 0.7 to 9.0 mm, preferably between 55 to 90 wt % of all ingredients have a median particle diameter Dv50 between 0.7 to 9.0 mm, preferably between 45 to 90 wt % of all ingredients have a median particle diameter Dv50 between 0.7 to 4.0 mm, preferably between 50 to 90 wt % of all ingredients have a median particle diameter Dv50 between 0.7 to 4.0 mm, preferably between 55 to 90 wt % of all ingredients have a median particle diameter Dv50 between 0.7 to 4.0 mm, preferably between 60 to 90 wt % of all ingredients have a median particle diameter Dv50 between 0.7 to 9.0 mm, preferably between 60 to 90 wt % of all ingredients have a median particle diameter Dv50 between 0.7 to 4.0 mm, preferably between 65 to 90 wt % of all ingredients have a median particle diameter Dv50 between 0.7 to 4.0 mm, preferably between 70 to 90 wt % of all ingredients have a median particle diameter Dv50 between 0.7 to 9.0 mm, preferably between 70 to 90 wt % of all ingredients have a median particle diameter Dv50 between 0.7 to 4.0 mm, preferably at least 45 wt % of all ingredients have a median particle diameter Dv50 above 0.8 mm, preferably at least 50 wt % of all ingredients have a median particle diameter Dv50 above 0.8 mm, preferably at least 55 wt % of all ingredients have a median particle diameter Dv50 above 0.8 mm, preferably at least 60 wt % of all ingredients have a median particle diameter Dv50 above 0.8 mm, preferably at least 65 wt % of all ingredients have a median particle diameter Dv50 above 0.8 mm, preferably at least 70 wt % of all ingredients have a median particle diameter Dv50 above 0.8 mm, preferably at least 75 wt % of all ingredients have a median particle diameter Dv50 above 0.8 mm, preferably at least 80 wt % of all ingredients have a median particle diameter Dv50 above 0.8 mm, preferably between 45 to 90 wt % of all ingredients have a median particle diameter Dv50 above 0.8 mm, preferably between 50 to 90 wt % of all ingredients have a median particle diameter Dv50 above 0.8 mm, preferably between 55 to 90 wt % of all ingredients have a median particle diameter Dv50 above 0.8 mm, preferably between 60 to 90 wt % of all ingredients have a median particle diameter Dv50 above 0.8 mm, preferably between 65 to 90 wt % of all ingredients have a median particle diameter Dv50 above 0.8 mm, preferably between 45 to 90 wt % of all ingredients have a median particle diameter Dv50 between 0.8 to 9.0 mm, preferably between 50 to 90 wt % of all ingredients have a median particle diameter Dv50 between 0.8 to 9.0 mm, preferably between 55 to 90 wt % of all ingredients have a median particle diameter Dv50 between 0.8 to 9.0 mm, preferably between 45 to 90 wt % of all ingredients have a median particle diameter Dv50 between 0.8 to 4.0 mm, preferably between 50 to 90 wt % of all ingredients have a median particle diameter Dv50 between 0.8 to 4.0 mm, preferably between 55 to 90 wt % of all ingredients have a median particle diameter Dv50 between 0.8 to 4.0 mm, preferably between 60 to 90 wt % of all ingredients have a median particle diameter Dv50 between 0.8 to 4.0 mm, preferably between 65 to 90 wt % of all ingredients have a median particle diameter Dv50 between 0.8 to 9.0 mm, preferably between 65 to 90 wt % of all ingredients have a median particle diameter Dv50 between 0.8 to 4.0 mm, preferably between 70 to 90 wt % of all ingredients have a median particle diameter Dv50 between 0.8 to 9.0 mm, preferably between 70 to 90 wt % of all ingredients have a median particle diameter Dv50 between 0.8 to 4.0 mm, preferably at least 45 wt % of all ingredients have a median particle diameter Dv50 above 0.9 mm, preferably at least 50 wt % of all ingredients have a median particle diameter Dv50 above 0.9 mm, preferably at least 55 wt % of all ingredients have a median particle diameter Dv50 above 0.9 mm, preferably at least 60 wt % of all ingredients have a median particle diameter Dv50 above 0.9 mm, preferably at least 65 wt % of all ingredients have a median particle diameter Dv50 above 0.9 mm, preferably at least 70 wt % of all ingredients have a median particle diameter Dv50 above 0.9 mm, preferably at least 75 wt % of all ingredients have a median particle diameter Dv50 above 0.9 mm, preferably between 45 to 90 wt % of all ingredients have a median particle diameter Dv50 above 0.9 mm, preferably between 50 to 90 wt % of all ingredients have a median particle diameter Dv50 above 0.9 mm, preferably between 55 to 90 wt % of all ingredients have a median particle diameter Dv50 above 0.9 mm, preferably between 60 to 90 wt % of all ingredients have a median particle diameter Dv50 above 0.9 mm, preferably between 65 to 90 wt % of all ingredients have a median particle diameter Dv50 above 0.9 mm, preferably between 45 to 90 wt % of all ingredients have a median particle diameter Dv50 between 0.9 to 9.0 mm, preferably between 55 to 90 wt % of all ingredients have a median particle diameter Dv50 between 0.9 to 9.0 mm, preferably between 45 to 90 wt % of all ingredients have a median particle diameter Dv50 between 0.9 to 4.0 mm, preferably between 50 to 90 wt % of all ingredients have a median particle diameter Dv50 between 0.9 to 4.0 mm, preferably between 55 to 90 wt % of all ingredients have a median particle diameter Dv50 between 0.9 to 4.0 mm, preferably between 60 to 90 wt % of all ingredients have a median particle diameter Dv50 between 0.9 to 4.0 mm, preferably between 65 to 90 wt % of all ingredients have a median particle diameter Dv50 between 0.9 to 9.0 mm, preferably between 65 to 90 wt % of all ingredients have a median particle diameter Dv50 between 0.9 to 4.0 mm, preferably between 70 to 90 wt % of all ingredients have a median particle diameter Dv50 between 0.9 to 9.0 mm, preferably between 70 to 90 wt % of all ingredients have a median particle diameter Dv50 between 0.9 to 4.0 mm, preferably at least 45 wt % of all ingredients have a median particle diameter Dv50 above 1.0 mm, preferably at least 50 wt % of all ingredients have a median particle diameter Dv50 above 1.0 mm, preferably at least 55 wt % of all ingredients have a median particle diameter Dv50 above 1.0 mm, preferably at least 60 wt % of all ingredients have a median particle diameter Dv50 above 1.0 mm, preferably at least 65 wt % of all ingredients have a median particle diameter Dv50 above 1.0 mm, preferably at least 70 wt % of all ingredients have a median particle diameter Dv50 above 1.0 mm, preferably between 55 to 90 wt % of all ingredients have a median particle diameter Dv50 above 1.0 mm, preferably between 60 to 90 wt % of all ingredients have a median particle diameter Dv50 above 1.0 mm, preferably between 45 to 90 wt % of all ingredients have a median particle diameter Dv50 between 1.0 to 4.0 mm, preferably between 50 to 90 wt % of all ingredients have a median particle diameter Dv50 between 1.0 to 4.0 mm, preferably between 55 to 90 wt % of all ingredients have a median particle diameter Dv50 between 1.0 to 4.0 mm, preferably between 60 to 90 wt % of all ingredients have a median particle diameter Dv50 between 1.0 to 4.0 mm, preferably between 65 to 90 wt % of all ingredients have a median particle diameter Dv50 above 1.0 mm, preferably between 65 to 90 wt % of all ingredients (by weight of the composition) have a median particle diameter Dv50 between 1.0 to 9.0 mm, preferably between 65 to 90 wt % of all ingredients (by weight of the composition) have a median particle diameter Dv50 between 1.0 to 4.0 mm. The median particle diameter Dv50 of all ingredients need to be understand, that in case the median particle diameter Dv50 of all ingredients are measured individual, that the total calculated median particle diameter Dv50 is within the mentioned values.

In an embodiment of the invention the term “saccharide” according to this invention means ingredients selected from the group consisting of sucrose, inulin, maltodextrin, dextrin, glucose, fructose, galactose, mannose, maltitol, isomalt, raffinose, stachyose, iso-malto-oligosaccharide, xylo-oligosaccharide, fructo-oligosaccharide, galacto-oligosaccharide, resistant-dextrin, isomaltulose, glucose syrup, rice syrup, agave syrup, corn syrup, oligosaccharide or any combination thereof. The term “saccharide” according to this invention means a saccharide having an average molecular weight below 20 kDa, preferably below 10 kDa, preferably below 6 kDa, preferably between 0.3 to 20 kDa, preferably between 0.5 to 10 kDa, preferably between 0.5 to 6 kDa, preferably between 0.7 to 20 kDa, preferably between 0.7 to 10 kDa, preferably between 0.7 to 6 kDa. In a further embodiment, the bouillon tablet comprises saccharide in an amount in the range of 5 to 40 wt % (by weight of the composition), preferably between 5 to 35 wt %, preferably 5 to 30 wt %, preferably 5 to 25 wt %, preferably 5 to 20 wt %, preferably 8 to 40 wt %, preferably 8 to 30 wt %, preferably 8 to 25 wt %, preferably 8 to 20 wt %, preferably 10 to 40 wt %, preferably 10 to 35 wt %, preferably 10 to 30 wt %, preferably 10 to 25 wt %, preferably 10 to 20 wt % (by weight of the composition).

The term “saccharide solution” according to this invention means an aqueous saccharide solution. The ingredients of the saccharide solution having an average molecular weight below 20 kDa, preferably below 10 kDa, preferably below 6 kDa, preferably between 0.3 to 20 kDa, preferably between 0.5 to 10 kDa, preferably between 0.5 to 6 kDa, preferably between 0.7 to 20 kDa, preferably between 0.7 to 10 kDa, preferably between 0.7 to 6 kDa. In an embodiment of the invention the term “saccharide solution” according to this invention means ingredients selected from the group consisting of sucrose, inulin, maltodextrin, dextrin, glucose, fructose, galactose, mannose, maltitol, isomalt, raffinose, stachyose, iso-malto-oligosaccharide, xylo-oligosaccharide, fructo-oligosaccharide, galacto-oligosaccharide, resistant-dextrin, isomaltulose, glucose syrup, rice syrup, agave syrup, corn syrup, oligosaccharide or any combination thereof.

In a further embodiment, the bouillon tablet comprises that the saccharide solution has a Brix value between 72 to 87°, preferably between 73 to 86°, preferably 74 to 86°, preferably 74 to 85°, preferably 75 to 86°, preferably 75 to 85°, preferably 75 to 84°, preferably 75 to 83°, preferably 76 to 86°, preferably 76 to 85°, preferably 75 to 84°, preferably 75 to 83°, preferably 75 to 82°, preferably 76 to 86°, preferably 76 to 85°, preferably 76 to 84°, preferably 76 to 83°, preferably 77 to 86°, preferably 77 to 85°, preferably 77 to 84°, preferably 77 to 83°, preferably 77 to 82°, preferably 78 to 86°, preferably 78 to 85°, preferably 78 to 84°, preferably 78 to 83°, preferably 78 to 82°.

As can be shown in the example section, the Brix of the carbohydrate solution itself is an essential feature in the process of the invention. In case of a Brix below 72° it is possible to obtain a product but nevertheless the process performance is not good as the bouillon mass is too sticky, which causes difficulties during mixing, slab forming as the formed slab is not uniformly and also that the mass is still sticky during cutting. A not uniformly formed slab result in weight differences of the final bouillon tablet. In case of Brix above 87° it is possible again to obtain a product but the process performance is again not good as the bouillon mass is too dry, which causes difficulties that the carbohydrate solution is homogenously distributed and the product is too brittle for cutting and smaller particles split of. This result in unexceptional weight variations of the bouillon tablet and higher loss of material.

The term “Brix” according to this invention means the sugar content of an aqueous solution. One degree Brix is 1 gram of sucrose in 100 grams of solution and represents the strength of the solution as percentage by mass. If the solution contains dissolved solids other than pure sucrose, then the ° Bx only approximates the dissolved solid content. The value of the Brix has been measured with the method for ° Brix determination per refactrometry at 20° C.: ISO 2173: 2003—Fruit and vegetable products—determination of soluble solids —refractometric method. By cooking the saccharide solution at a temperature between 100 to 130° C., preferably between 100 to 125° C., between 105 to 125° C. can be adjusted especially in the Brix value from the starting material is too low. By adding water the amount of Brix can be lowered.

The saccharide solution is heated to a flow-able state before added to a dry composition, preferably to a temperature between 70° C. to 110° C., preferably between 75° C. and 100° C., preferably between 75 to 95° C., preferably between 80 to 90° C. The optimal temperature can be determined by a skilled artisan. The saccharide solution is intimately and gently blended with a mix comprising crystalline ingredients, pieces of plant material and optionally amorphous ingredients. Usually, the saccharide solution is added to a dry mix. A single screw mixer or double screw mixer or a batch cooker may be used for heating the saccharide solution and blending it with the mix. The saccharide solution should be fluid enough to coat the food pieces evenly. At a lower temperature, the saccharide solution remains too viscous and there is a risk that dry food pieces get broken by friction and/or the saccharide solution is not evenly distributed. A higher temperature, does not bring an improved blending, may provoke undesired reactions in the saccharide solution and is associated to increased energy consumption. In an embodiment the saccharide solution has a viscosity in the range of 30 to 1000 mPa·s at shear rate of 50 s-1 at 90° C., preferably in the range of 30 to 900 mPa·s at shear rate of 50 s-1 at 90° C., preferably in the range of 30 to 800 mPa·s at shear rate of 50 s-1 at 90° C., preferably in the range of 30 to 700 mPa·s at shear rate of 50 s-1 at 90° C., preferably in the range of 30 to 600 mPa·s at shear rate of 50 s-1 at 90° C., preferably in the range of 40 to 1000 mPa·s at shear rate of 50 s-1 at 90° C., preferably in the range of 40 to 900 mPa·s at shear rate of 50 s-1 at 90° C., preferably in the range of 40 to 800 mPa·s at shear rate of 50 s-1 at 90° C., preferably in the range of 40 to 700 mPa·s at shear rate of 50 s-1 at 90° C., preferably in the range of 40 to 600 mPa·s at shear rate of 50 s-1 at 90° C., preferably in the range of 50 to 1000 mPa·s at shear rate of 50 s-1 at 90° C., preferably in the range of 50 to 900 mPa·s at shear rate of 50 s-1 at 90° C., preferably in the range of 50 to 800 mPa·s at shear rate of 50 s-1 at 90° C., preferably in the range of 50 to 700 mPa·s at shear rate of 50 s-1 at 90° C., preferably in the range of 50 to 600 mPa·s at shear rate of 50 s-1 at 90° C. All the Brix value of the carbohydrate solution according to the invention and all the ranges of viscosity of the carbohydrate solution according to the invention can be combined.

In a further embodiment, the process for the production of a bouillon tablet comprises, that 10 to 30 wt % of the saccharide solution are added to 70 to 90 wt % of the dry composition, preferably 12 to 28 wt % of the saccharide solution are added to 72 to 88 wt % of the dry composition, preferably 15 to 25 wt % of the saccharide solution are added to 75 to 85 wt % of the dry composition, preferably 17 to 23 wt % of the saccharide solution are added to 77 to 83 wt % of the dry composition.

In the context of the present invention, the term “fat” refers to triglycerides solid at a temperature of 25° C. The term “solid at a temperature of 25° C.” means that the fat, stored at this temperature, maintains its shape. Fats and oils are the chief component of animal adipose tissue and many plant seeds. The fat according to this invention have a solid fat content greater than 2% at 30° C., preferably it have a solid fat content greater than 5% at a temperature of 30° C., preferably it have a solid fat content greater than 10% at a temperature of 30° C. The solid fat content of a fat for example be measured by pulsed NMR. Fat according to this invention means a vegetable and/or animal fat. In a further embodiment fat according to this invention means at least one ingredient of tropical fat, fractionated tropical fat, fractionated beef fat, beef fat, fractionated chicken fat, chicken fat, algae fat or shea butter, interesterified shea butter. In a further embodiment, the bouillon tablet comprises up to 7 wt % (by weight of the composition) fat, preferably up to 5 wt %, preferably up to 3 wt %, preferably in the range of 0 to 7 wt %, preferably between 0.5 to 7 wt %, preferably between 0.5 to 5 wt %, preferably between 0.5 to 3 wt % (by weight of the composition). Nowadays there is a nutritional trend to avoid or at least reduce consumption of fats rich in trans fatty acids and saturated fatty acids and to preferably consume healthy oils rich in polyunsaturated fatty acids. It is advantageous to provide a hard bouillon tablet which only or mainly contains oil that is liquid at ambient temperatures in local conditions and no or only little amounts of solid fat. In an embodiment, the bouillon tablet contains less than 5% saturated fat; preferably less than 3% saturated fat, preferably less than 1% saturated fat, more preferably the bouillon tablet contains no fat (0 wt % fat).

In an embodiment, the bouillon tablet further comprises oil, for example up to 10 wt % oil (by weight of the composition), preferably up to 7 wt % oil, preferably up to 5 wt % oil, preferably up to 2 wt % oil, preferably the composition comprises oil in an amount in the range of 0 to 10% (by weight of the composition), preferably between 0 to 5%, preferably between 0.1 to 10%, preferably between 0.1 to 7%, preferably between 0.1 to 5%, preferably between 0.1 to 2% (by weight of the composition). In a preferred embodiment, the oil is a vegetable oil. Preferably, the oil is selected from the group consisting of sunflower oil, rape seed oil, cotton seed oil, peanut oil, soya oil, olive oil, coconut oil, algal oil, safflower oil, corn oil, rice bran oil, sesame oil, hazelnut oil, avocado oil, almond oil, walnut oil or a combination thereof; more preferably sunflower oil. The term sunflower oil includes also high oleic sunflower oil. In the context of the present invention the term “oil” refers to triglycerides which are liquid or pourable at a room temperature of 20° C., for example liquid or pourable at a room temperature of 25° C. The oil have a solid fat content of less than 10% at 20° C., preferably less than 5% at 20° C., preferably less than 2% at 20° C., preferably 0% at 20° C. The oil may be rich in monounsaturated and polyunsaturated fatty acids. In an embodiment, the bouillon tablet contains less than 3 wt % oil; preferably contains less than 2 wt % oil, more preferably no oil (0 wt % oil).

In an embodiment the water content of the mix before forming a bouillon tablet is between 4.0 to 13.0 wt % (by weight of the composition), preferably between 4.0 to 11.0 wt %, preferably between 4.0 to 10.0 wt %, preferably between 4.5 to 10.0 wt %, preferably between 5.0 to 9.5 wt %, preferably between 5.0 to 9.0 wt %, preferably between 5.5 to 8.5 wt %. The water content is most likely adjusted by adding the saccharide solution to the mixed composition before forming a bouillon tablet. The pressed tablet is dried and therefore the mentioned water content is before drying the tablet.

In an embodiment “forming” means processing steps to obtain a bouillon tablet comprising
i) a slab forming of the bouillon mass;
ii) cooling the slab;
iii) cutting of the cooled slab.

In an embodiment “forming” means processing steps to obtain a bouillon tablet comprising
i) a slab forming of the bouillon mass;
ii) cooling the slab;
iii) a longitudinal cutting of the cooled slab to obtain strands;
iv) a cross cutting of the strands.

A standard bouillon process for hard bouillons can't be used. A pressing die is not used. The slab is formed with at least one roller, preferably between 1 to 3 rollers, preferably 1 roller, preferably 2 rollers. The roller(s) is/are used to have a certain intended height of the slab. In a preferred embodiment the roller is heated to a temperature between 40-90° C.

In an embodiment the cutting can be done by any suitable cutting device, preferably a guillotine cut, roller cut, water jet cut, laser cut or a combination thereof, preferably roller cut and/or guillotine cut.

In an embodiment the longitudinal cutting can be done by any suitable cutting device, preferably a guillotine cut, roller cut, water jet cut or a combination thereof, preferably roller cut.

In an embodiment the cross cutting can be done by any suitable cutting device, preferably a guillotine cut, roller cut, water jet cut or a combination thereof, preferably guillotine cut.

Cooling the slab means, that the temperature is cooled to a temperature between 10 to 60° C., preferably to a temperature between 15 to 50° C., preferably to a temperature between 20 to 50° C., preferably to a temperature between 20 to 40° C., preferably to a temperature between 15 to 30° C.

The drying step can be carried out by any commonly known drying technique such as air drying, oven drying, vacuum drying, bed drying, microwave-vacuum drying, infrared radiation drying or combinations thereof. The drying step does not include spray drying. In an embodiment of the invention the drying is done at a temperature between 50 to 150° C., preferably between 50 to 130° C., preferably between 60 to 130° C., preferably between 70 to 130° C., preferably between 80 to 120° C., preferably between 100 to 120° C. The drying time is between 1 min to 5 hours, preferably between 5 min to 3 hours.

In an embodiment, the composition of the bouillon tablet has a density below 1.15 g/cm3, preferably below 1.1 g/cm3, preferably below 1.0 g/cm3, preferably between 0.6 to 1.15 g/cm3, preferably between 0.6 to 1.1 g/cm3, preferably between 0.7 to 1.1 g/cm3, preferably between 0.7 to 1.0 g/cm3, preferably between 0.75 to 0.95 g/cm3.

In an embodiment the bouillon tablet is shelf-stable over 12 months and therefore has a water activity of below 0.6, preferably below 0.5, preferably below 0.4, preferably between 0.06 to 0.6, preferably between 0.1 to 0.5, preferably between 0.15 to 0.4.

In an embodiment, the bouillon tablet has a tablet hardness of at least 80 N, preferably at least 90N, preferably at least 100N, preferably at least 110N, preferably at least 120N, preferably between 80 to 800N, preferably between 80 to 600N, preferably between 80 to 500N, preferably between 80 to 400N, preferably between 90 to 800N, preferably between 90 to 600N, preferably between 90 to 500N, preferably between 90 to 400N, preferably between 100 to 800N, preferably between 100 to 600N, preferably between 100 to 500N, preferably between 100 to 400N.

In an embodiment, the bouillon tablet does not contain xanthan. In a further embodiment, the bouillon tablet does not contain a food grade blue-coloured ingredient.

### EXAMPLES

The invention is further described with reference to the following examples. It is to be appreciated that the examples do not in any way limit the invention.

### Example 1: Process

The general procedure for preparing a bouillon tablet of the invention is as follows:
Mixing ingredients comprising crystalline ingredient, pieces of plant material and optionally amorphous ingredient to obtain a dry composition;
Adding a saccharide solution to the dry composition of step a) and further mix to result in a bouillon mass;
a slab forming of the bouillon mass;
cooling the slab;
a longitudinal cutting of the cooled slab to obtain strands
a cross cutting of the strands.
Drying the bouillon tablet;
   All dry ingredients (crystalline salt, crystalline sugar, pieces of plant material and optionally amorphous ingredients) were weighted and then mixed manually. To adjust the necessary Brix value the saccharide solution (Beneo Orafti L85; Beneo Remylose 58 80; Norevoi EU Bio Agave Syrup Salmiana) has been cooked between a temperature of 105 to 120° C. (Thermosyphon Cooker). The saccharide solution has been added at a temperature between 80-90° C. (Buhler Continuous Mixer Contimix 700 Easy Clean™; Basically a double screw mixer with can be heated or cooled). The resulting mixture was then immediately used to form a slab (Buhler Smooth Roller Former GP M 200-400 HD). The slab has been cooled to 20° C. (Buhler Cooling Tunnel HKK 420) and longitudinal cut into strands (Buhler Strand Slitter SG 420 HD). The strand has been cross cutted (Buhler MS 620 EIV/TB HD) and the resulting bouillon tablet has been dried (standard drier).

### Viscosity Measurement:

The viscosity of the carbohydrate solution has been measured by using a modular compact Rheometer (Anton Paar Physica MCR 300; measuring system CC17), at a shear rate of 50s-1 at 90° C.”

### Density Measurement:

Dimensions of bouillon tablet is measured from three dimensions using TESA Dial Calliper 0.02 mm ANTICHOC 05.10008. Each dimension is measured three times and the average is taken for volume calculation. The product is weighted using PG5002-S Delta Range balance (Mettler-Toledo GmbH, Switzerland). The density is calculated: density=weight (g)/volume (cm3). Five products are used and the average density is reported.

### Particle Size Distribution:

The particle size distribution is measured by Retsch AS200 according to ISO 2395:1990. The selected sieves from the following range are used: 4000 μm, 3150 μm, 2500 μm, 2000 μm, 1600 μm, 1250 μm, 1000 μm, 710 μm, 500 μm, 400 μm, 250 μm, 125 μm, and 63 μm. Sieving time is 10 minutes and amplitude 1 mm. Interpretation of the results is by applying the logarithmic form of the equation of Rosin, Rammler and Sperling (RRS). Based on the results Dv50 are reported.

### Particle Size Distribution:

The particle size distribution is measured by Retsch AS200, the selected sieves from the following range are used: 4000 μm, 3150 μm, 2500 μm, 2000 μm, 1600 μm, 1000 μm, 800 μm and 710 μm. Sieving time is 10 minutes and amplitude 1 mm. Based on the results Dv50 are reported.

### Water Content:

Water content determination was based on the official method ISO 1666:1996 Starch—Determination of moisture content—Oven-drying. The method is applied to different matrix with minor modifications. Approx. 100 g of sample was milled with Grindomix GM200 (Retsch GmbH, Germany) at 8000 RPM for 8 s. Evaporating Nickel dish and its lid (VWR parts number 253-029) were weighed with XP204 balance (Mettler-Toledo GmbH, Switzerland) and the mass were reported with 0.1 mg accuracy. Subsequently, approx. 3 gram of test portion of sample were placed in the nickel dish. Weight of the dish with its lid and the sample was immediately determined. The dish, with its lid on the side, were placed in oven that has been set to 102±1° C. for 240 minute (4 h). After drying in the oven, the dish was closed with its lid and immediately transferred to a desiccator for 60 minute. The dish, with its lid and the dried sample, was weighed immediately after removed from desiccator. Mass fraction of moisture (M) was reported in g/100 g of sample and determined as:

$$M = \frac{{m}_{1} - {m}_{0}}{{m}_{2} - {m}_{0}} \times 100$$

with m₀ is the mass of the dish and its lid, m₁ the mass of the dish with its lid and the sample before drying, and m₂ the mass of the dish with its lid and the sample after drying in oven.

### Examples 2 to 13

Examples 2 and 13 have been prepared according to example 1.

| | Comp. | | | |
|---|---|---|---|---|
| Recipe | Ex. 2 | Ex. 3 | Ex. 4 | Ex. 5 |
| Salt [wt %]; | 37.5 | 37.5 | 37.5 | 37.5 |
| Dv50 = 1.15 mm | | | | |
| Pieces of plant material | 36 | 36 | 36 | 36 |
| (onion, garlic, tomato, | | | | |
| pepper, parsley, leek, | | | | |
| coriander) [wt %]; | | | | |
| Dv50 between 1.1 to 2.5 mm | | | | |
| Amorphous ingredient [wt %] | 6.5 | 6.5 | 6.5 | 6.5 |
| Type of saccharide | Inulin | Inulin | Inulin | Inulin |
| saccharide solution [wt %] | 20 | 20 | 20 | 20 |
| Brix of saccharide solution | 71° | 74° | 77° | 82° |
| Viscosity of carbohydrate | 27 | 45 | 67 | 294 |
| solution at 90° C. (measured | | | | |
| at shear rate of 50 s−1) | | | | |
| [mPa · s] | | | | |
| Average Hardness (N) after | 575 | 570 | 560 | 550 |
| drying 3 h at 70° C. | | | | |
| Density [g/cm3] | 0.86 | 0.87 | 0.87 | 0.86 |
| Process performance | Too much | Acceptable | Good | Good |
| | water; sticky | formability | formability | formability |
| | mass; difficult | | | |
| | to cut | | | |

| | | Comp | | |
|---|---|---|---|---|
| Recipe | Ex. 6 | Ex. 7 | Ex. 8 | Ex. 9 |
| Salt [wt %]; | 37.5 | 37.5 | 37.5 | 37.5 |
| Dv50 = 1.15 mm | | | | |
| Pieces of plant material | 36 | 36 | 36 | 36 |
| (onion, garlic, tomato, | | | | |
| pepper, parsley, leek, | | | | |
| coriander) [wt %]; | | | | |
| Dv50 between 1.1 to 2.5 mm | | | | |
| Amorphous ingredient [wt %] | 6.5 | 6.5 | 6.5 | 6.5 |
| Type of saccharide | Inulin | Inulin | Agave syrup | Rice syrup |
| saccharide solution [wt %] | 20 | 20 | 20 | 20 |
| Brix of saccharide solution | 85° | 88° | 80° | 80° |
| Viscosity of carbohydrate | 753 | 2222 | 56 | 104 |
| solution at 90° C. (measured | | | | |
| at shear rate of 50 s−1) | | | | |
| [mPa · s] | | | | |
| Average Hardness (N) after | 550 | 520 | 180 | 620 |
| drying 3 h at 70° C. | | | | |
| Density [g/cm3] | 0.86 | 0.86 | 0.85 | 0.85 |
| Process performance | Acceptable | Too dry, no | Good | Good |
| | formability | homogenous | formability | formability |
| | | mixing or | | |
| | | wetting of | | |
| | | mass; too | | |
| | | brittle to cut | | |

| Recipe | Ex. 10 | Ex. 11 | Ex. 12 | Ex. 13 |
|---|---|---|---|---|
| Salt [wt %]; | 37.5 | 37 | 37 | 33 |
| Dv50 = 1.15 mm | | | | |
| Sugar [wt %]; | — | — | — | 4 |
| Dv50 = 0.60 mm | | | | |
| Pieces of plant material | 36 | 39.5 | 41 | 37.5 |
| (onion, garlic, tomato, | | | | |
| pepper, parsley, leek, | | | | |
| coriander) [wt %]; | | | | |
| Dv50 between 1.1 to 2.5 mm | | | | |
| Amorphous ingredient [wt %] | 6.5 | 7.5 | — | 7.5 |
| Type of saccharide | Agave syrup/ | Agave syrup | Inulin | Agave syrup/ |
| | Rice syrup | | | Inulin 50/50 |
| | 80/20 | | | |
| saccharide solution [wt %] | 20 | 16 | 22 | 18 |
| Brix of saccharide solution | 80° | 80° | 80° | 80° |
| Viscosity of carbohydrate | 64 | 56 | 149 | 95 |
| solution at 90° C. (measured | | | | |
| at shear rate of 50 s−1) | | | | |
| [mPa · s] | | | | |
| Average Hardness (N) after | 240 | 290 | 530 | 450 |
| drying 3 h at 70° C. | | | | |
| Density [g/cm3] | 0.86 | 0.85 | 0.85 | 0.85 |
| Process performance | Good | Good | Good | Good |
| | formability | formability | formability | formability |

Examples 2 to 13 have been prepared according to example 1. As a comparison the density of different commercial available bouillon tablets have been measured (Maggi Chicken Bouillon Volaille, Maggi Doble Gusto Costilla and Maggi KUP OR) and showing a density between 1.38 to 1.61 g/cm3. As can be shown by the examples 2 to 7 the Brix of the saccharide solution is an essential feature. Comparison example 2 has a lower Brix according to the invention and even it is possible to obtain a product the process performance is not good as the bouillon mass is too sticky, which causes difficulties during mixing, slab forming as the formed slab is not uniformly and also that the mass is still sticky during cutting. A not uniformly formed slab result in weight differences of the final bouillon tablet. Comparison example 7 has a higher Brix according to the invention and even also here it is possible to obtain a product but the process performance is again not good as the bouillon mass is too dry, which causes difficulties that the saccharide solution is homogenously distributed and the product is too brittle for cutting and smaller particles split of. This result in unexceptional weight variations of the bouillon tablet and higher loss of material. Example 8 to 13 shows the result for different saccharide solutions or combination of saccharide solutions.

### Example 14: Disintegration Time

The disintegration time of the bouillon tablet of the invention has been compared with a commercial available standard bouillon tablet (Maggi bio vegetable bouillon tablet). Water was heated to a temperature between 95° C. to 100° C. (boiling water). The bouillon tablet has been added to 500 ml of the boiling water without stirring and the time measured until the bouillon tablet is disintegrated. The disintegration time for examples 3 to 6 and 8 to 11 are between 45 to 80 seconds, wherein the standard bouillon tablets needs 3:55 to 4:30 min to disintegrate completely.

### Example 15: Natural Appearance

20 internal experienced panelists were used to rate the visible aspect of the bouillon tablet of the invention. All of them appreciated the natural look as the ingredients and especially the pieces of plant material (garnishes, herbs and spices are visible). In addition the bouillon tablet of the invention looks more fresh and healthier for them compared to the commercial available standard bouillon tablets. FIG. 1 shows a commercial bouillon tablet and a bouillon tablet of the invention with the visible ingredients.

### Examples 16-19

Examples 17 to 19 have been prepared according to example 1. Example 16 has been prepared similar to example 1 but except to use a saccharide solution only the corresponding amount of water has been used.

| | Comp. | Comp. | | |
|---|---|---|---|---|
| Recipe | Ex. 16 | Ex. 17 | Ex. 18 | Ex. 19 |
| Salt [wt %] | 46 | 46 | 38 | |
| Dv50 = 0.40 mm | | | | |
| Salt [wt %] | | | 8 | 46 |
| Dv50 = 1.15 mm | | | | |
| Pieces of plant material | 40 | | | |
| (onion, garlic, tomato, | | | | |
| pepper, parsley, leek, | | | | |
| coriander) [wt %]; | | | | |
| Dv50 between 0.30 to 0.45 mm | | | | |
| Pieces of plant material | | 40 | 40 | 40 |
| (onion, garlic, tomato, | | | | |
| pepper, parsley, leek, | | | | |
| coriander) [wt %]; | | | | |
| Dv50 between 1.1 to 2.5 mm | | | | |
| Amorphous ingredient [wt %] | 14 | 0 | 0 | 0 |
| Inulin [wt %] | — | 14 | 14 | 14 |
| Density [g/cm3] | 1.41 | 1.17 | 1.01 | 0.81 |
| Disentegration time [min] | 3:50 | 2:10 | 1:45 | 0.45 |

Comparison examples 16, 17 and examples 18, 19 show, that at least 45 wt % of all ingredients needs to have a median particle diameter Dv50 above 0.6 mm to obtain a bouillon tablet having a density below 1.15 and a disintegration time of the bouillon tablet less than 2 min. The disintegration time is measured according to example 14. In addition according to example 15 the natural appearance of example 19 has been rated as the highest followed by example 18. The natural appearance of comparison example 16 is the lowest. Example 17 has been rated lower as comparison example 18.

### Comparison Example 20

3 different granules have been prepared using standard preparation methods with the following composition.

| Granules | salt | sugar | MSG | Flavor/color | starch |
|---|---|---|---|---|---|
| Yellow | 51 | 9 | 31 | 9 | |
| Green | 35 | 8 | 40 | 7 | 10 |
| Brown | 34 | 10 | 5 | 18 | 33 |

The granules have a water content of 6 wt % before pressing and the particle size is between 1.2 to 1.5 mm long and having 0.8 mm width. The different granules have been used to press a bouillon tablet according to WO2004112513. The resulted bouillon tablet is dried and has a marbled color with a smooth surface as the structure of the granules are destroyed after pressing. The density [g/cm3] of the bouillon tablet is 1.46 g/cm3 and therefore similar to a standard bouillon tablet. According to example 14 the disintegration time of the bouillon tablet resulting from the granules has been measured. The disintegration time is 3:45 min. According to example 15 the visible aspect of the bouillon tablet has been rated. All 20 internal experienced panelists appreciated the natural look of the bouillon tablet obtained of the process of the invention as the ingredients and especially the pieces of plant material (garnishes, herbs and spices) are visible. In addition the bouillon tablet of the invention looks more fresh and healthier for them compared to the bouillon tablet resulting from the granules. Despite the fact of a marbled visual effect the bouillon tablet resulting from granules is very similar to a standard bouillon tablet pressed from powder.

1. A bouillon tablet comprising:
i) 20-60 wt % crystalline salt (weight of the composition);
ii) 15-65 wt % pieces of plant material (weight of the composition);
iii) 5-40 wt % Saccharide (weight of the composition); and
the crystalline salt has a median particle diameter Dv50 in the range of 0.6 to 2.5 mm and wherein at least 45 wt % of all ingredients have a median particle diameter Dv50 above 0.6 mm.

2. A bouillon tablet according to claim 1, wherein the pieces of plant material have a median particle diameter Dv50 in the range of 0.7 to 9.0 mm

3. A bouillon tablet according to claim 1, wherein the pieces of plant material is selected from the group consisting of parsley, celery, fenugreek, lovage, rosemary, marjoram, dill, tarragon, coriander, leek, ginger, lemongrass, curcuma, chili, ginger, paprika, mustard, garlic, onion, shallots, turmeric, tomato, coconut, oregano, thyme, basil, chilies, paprika, mushrooms, pimento, jalapeno pepper, white pepper, black pepper and combinations of thereof.

4. A bouillon tablet according to claim 1, wherein the saccharide is selected from the group consisting of sucrose, inulin, maltodextrin, dextrin, glucose, fructose, galactose, mannose, maltitol, isomalt, raffinose, stachyose, iso-malto-oligosaccharide, xylo-oligosaccharide, fructo-oligosaccharide, galacto-oligosaccharide, resistant-dextrin, isomaltulose, glucose syrup, rice syrup, agave syrup, corn syrup, oligosaccharide and any combination thereof.

5. A bouillon tablet according to claim 1, wherein the bouillon tablet further comprises up to 10 wt % of an amorphous ingredient (weight of the composition).

6. A bouillon tablet according to claim 5, wherein the amorphous ingredient is selected from the group consisting of yeast extract, vegetable powder, animal extract, bacterial extract, vegetable extract, animal powder, reaction flavour, hydrolyzed plant protein, and any combination thereof.

7. A bouillon tablet according to claim 1, wherein at least 65 wt % of all ingredients have a median particle diameter Dv50 above 0.8 mm.

8. A bouillon tablet according to claim 1, wherein the bouillon tablet has a density below 1.15 g/cm3, preferably between 0.6 to 1.15 g/cm3.

9. A process for producing a bouillon tablet comprising the steps of:
a) mixing a crystalline ingredient, pieces of plant material and optionally an amorphous ingredient to obtain a dry composition;
b) adding a saccharide solution to the dry composition of step a) and further mixing to result in a bouillon mass;
c) forming a bouillon tablet from the bouillon mass;
d) drying the bouillon tablet; and
wherein the crystalline salt has a median particle diameter Dv50 in the range of 0.6 to 2.5 mm and at least 45 wt % of all ingredients have a median particle diameter Dv50 above 0.6 mm

10. A process for producing a bouillon tablet according to claim 9, wherein the saccharide solution has a viscosity in the range of 30 to 1000 mPa·s at shear rate of 50 s-1 at 90° C.

11. A process for producing a bouillon tablet according to claim 9, wherein the saccharide solution is added at a temperature between 70 to 110° C.

12. A process for producing a bouillon tablet according to claim 9, wherein the forming of the bouillon tablet comprises
i) a slab forming of the bouillon mass;
ii) cooling the slab; and
iii) cutting of the cooled slab.

13. A process for producing a bouillon tablet according to claim 12, wherein the cutting is done by a guillotine cut and/or roller cut.

14. A process for producing a bouillon tablet according to claim 9, wherein the drying is done at a temperature between 50 to 150° C.

15. (canceled)
